(19) United States
(12) Patent Application Publication
(10) Pub. No.: US 2017/0031897 A1
(43) Pub. Date: Feb. 2, 2017

(54) MODIFICATION OF INPUT BASED ON LANGUAGE CONTENT BACKGROUND

(71) Applicant: Lenovo (Singapore) Pte. Ltd., Singapore (SG)

(72) Inventors: Jianbang Zhang, Cary, NC (US); Ming Qian, Cary, NC (US); Jian Li, Chapel Hill, NC (US); Song Wang, Cary, NC (US)

(21) Appl. No.: 14/815,204

(22) Filed: Jul. 31, 2015

(51) Int. Cl. G06F 17/28; G06F 17/24; G06F 3/0488

(52) U.S. Cl. CPC G06F 17/28; G06F 3/04886; G06F 17/24

(57) ABSTRACT

One embodiment provides a method, including: implementing, using a processor, a current language setting for an input component of an electronic device; detecting, using a processor, a language type based on content data; determining, based on the content data, if the language type is mismatched with the current language setting; and responsive to the determining, automatically switching, using a processor, the current language setting to a language setting matching the language type. Other aspects are described and claimed.

### BACKGROUND

Information handling devices (“devices”), for example cell phones, smart phones, tablet devices and the like, have communication capabilities, including messaging application functionality. Users input text (whether via key inputs or other modes, e.g., handwriting inputs converted to text, voice inputs converted to text, etc.) into a communication or like application using an input component, e.g., a soft (onscreen) keyboard, a mechanical keyboard, a microphone and speech to text processing module, etc.

When inputting words or phrases, irrespective of the application, the device interprets these user inputs in a given language indicated by a current language setting. For example, in North America, the language setting may by default be set to English. However, there are times when a user wants or needs to provide inputs using a different language. In order to fully accomplish this task, often the current language setting (e.g., keyboard setting) will need to be changed. This provides the user with access to alternative keys that may not be available in the current language. A common example is a bilingual user that needs to switch between English and Spanish. Another common example is a user employing a language learning application, where the user needs to switch between providing inputs in more than one language repeatedly. Language settings may be altered by the user via manual inputs to open a settings menu and choose the desired language setting. After the user has manually set the language setting to the appropriate language, a user may thereafter provide inputs that are received in the new language.

### BRIEF SUMMARY

In summary, one aspect provides a method, comprising: implementing, using a processor, a current language setting for an input component of an electronic device; detecting, using a processor, a language type based on content data; determining, based on the content data, if the language type is mismatched with the current language setting; and responsive to the determining, automatically switching, using a processor, the current language setting to a language setting matching the language type.

Another aspect provides an information handling device, comprising: a processor; an input component; a memory device that stores instructions executable by the processor to: implement a current language setting for the input component of the information handling device; detect a language type based on content data; determine, based on the content data, if the language type is mismatched with the current language setting; and responsive to the determining, automatically switch the current language setting to a language setting matching the language type.

A further aspect provides a product, comprising: a storage device having code stored therewith, the code being executable by a processor and comprising: code that implements a current language setting for an input component of an electronic device; code that detects a language type based on content data; code that determines, based on the content data, if the language type is mismatched with the current language setting and; code that responsive to the determining, automatically switches the current language setting to a language setting matching the language type.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of modification of input method based on language content.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

In certain instances, e.g., for multi-lingual device users, users are required to manually change their on screen keyboard language by going through a manual settings change process. This is burdensome if the user is going back and forth between sending a message to a user of one language, and then sending other messages to users of a second language. Currently users are forced into a manual selection process to switch the language setting for the input component, e.g., soft (on screen) keyboard.

Particular Operating Systems (OS) can support multiple languages, this allows a user to install corresponding different language input method editors (IME), or enable multi-language settings for a single IME. Moreover, this allows the user to manually choose which language to input. For example, for Microsoft Windows 8, a user can use the shortcut keys “WIN+SPACE” to bring up the IME language selection window. MICROSOFT WINDOWS is a registered trademark of Microsoft Corporation in the United States of America and other countries. In an alternative example Android allows a user to click the “earth” icon located on the soft keyboard to change input language. ANDROID is a registered trademark of Google, Inc. in the United States of America and other countries.

It is very common for bilingual users to utilize different languages for different input fields across different applications. For example, a user might use Chinese script while using a text based chatting program with instant message (IM) abilities, while simultaneously attempting to type web address or email address which are generally English (Latin) only. As discussed herein, the current solutions force the user to manually switch between the multiple languages in a global fashion, e.g., manually changing the IME setting, which requires toggling back and forth. This act is not just aggravating to the user, but can cause a reduction in efficiency for multilingual users.

Thus, an embodiment may make use of the application or an input field within an application, to automatically select the right input language for a user. Additionally, the language change could happen actively or proactively. For example, an embodiment operating actively could use the input field's content, and based on that content allow the IME to read and interpret that data. Once the data is interpreted, the IME can make any corresponding changes. Additionally or alternately, an embodiment may act proactively whereby the target application can make a request through the IME application program interface (API) to select the language type.

Accordingly, an embodiment provides a method for real-time modification of input method based on language content, e.g., as determined from typed text input, text visible in a current application, previous history, etc. An embodiment, for a current language setting for an input component of an electronic device, detects language content using data accessible to the electronic device and determines if the language content is mismatched with the current language setting. If so, an embodiment automatically switches the current language setting to a language setting matching the language content detected.

Moreover, to understand what language to use for the target application or input field, additional context such as the application type, input field type, user's input history, etc. may be utilized. Several non-limiting example scenarios are: email address, web address, and password fields which may require Latin language input; each session of IM application, should set the active language to the same language used for previous conversations; if a user has switched back and forth between two applications, the automatic decision should be made to prevent further manual switch; an application e.g., a word document, when opened, can switch to a specific language based on what was stored in the file prior to opening; if a Chinese phrase, e.g., “ [symbol] ”, is detected, the IME may automatically change its language setting.

In one non-limiting embodiment, as the user is typing characters into the input component (e.g., keyboard), an embodiment identifies the language that is being typed as the user input is provided (i.e., in real-time) and modifies the language setting of the keyboard. If a user has already typed most of the word or phrase in a first language, e.g., without special accents, etc., an embodiment may use an autocorrect like method to make (or suggest) changes for the previous input.

As another non-limiting example, if a user generally types in a specific language to certain friends or family members, e.g., users stored in device contacts (whether on device on stored elsewhere), an embodiment may automatically change to the appropriate language based on a prior messages content history that user or contact, rather than (or in addition to) what is being typed.

The illustrated example embodiments will be best understood by reference to the figures. The following description is intended only by way of example, and simply illustrates certain example embodiments.

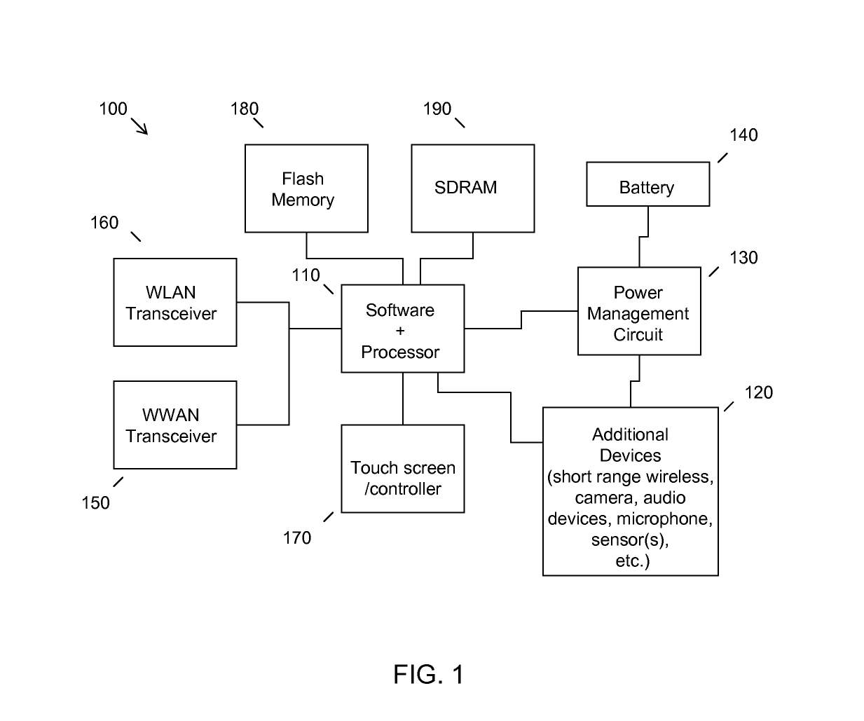

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera. System 100 often includes a touch screen 170 for data input and display/rendering. System 100 also typically includes various memory devices, for example flash memory 180 and SDRAM 190.

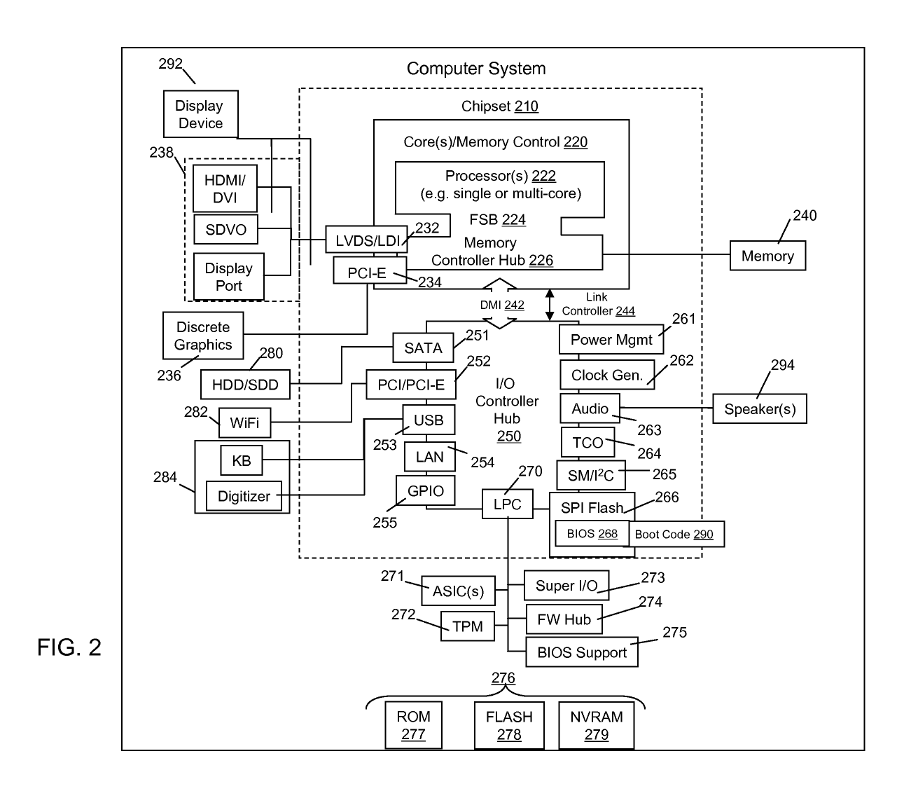

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices which users may use it input various languages into for document creation or communication purposes. For example, the circuitry outlined in FIG. 1 may be implemented in a tablet or smart phone embodiment, whereas the circuitry outlined in FIG. 2 may be implemented in a personal computer embodiment.

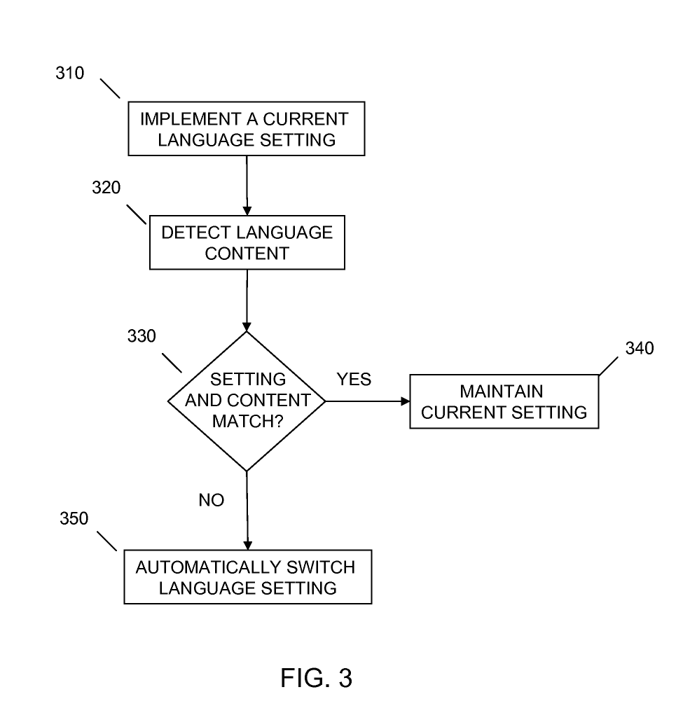

In an embodiment, and referring to FIG. 3, an embodiment will implement a current language setting at 310, e.g., English language, for an input component of an electronic device, e.g., soft (onscreen) keyboard of a tablet computing device. An embodiment may detect at 320, e.g., during a user providing input to the soft keyboard, a language content using data accessible to the electronic device e.g., current text displayed by the application, text entered by the user during pervious utilization, text currently being entered, etc.

Additionally, the data used to detect a language content at 320 may include, but is not limited to, previously entered user input to the input component, e.g., previously typed user input to the soft keyboard, or information known about any previously entered content. Moreover, in an embodiment, the language content can be limited to an actively selected application i.e., if a user has multiple applications open each application utilizing different languages, an embodiment may only analyze the active application (i.e., selected application) to determine language content.

Having the data from which to determine or infer language content, an embodiment may then determine at 330 if the language content is mismatched with the current language setting for the input component. If not mismatched, an embodiment may maintain the current language setting for the input component at 340.

Alternatively, if there is a mismatch determined at 330, an embodiment may automatically switch the current language setting at 350 to a language setting matching the language content detected. For example, an English language setting may be switched at 350 to a Spanish language setting responsive to detecting at 320 that the user is inputting a message (e.g., SMS text message) to a user contact known (e.g., via user content history) to prefer Spanish language messages.

In another embodiment, the user input may be received via audio data, e.g., a user's voice commands. Similar to previous embodiments, the content of the voice data is analyzed and a language type is determined at 320. Once the language type is determined, the language setting for the input component, e.g., a software keyboard, is set accordingly e.g., 340 if the content is a match and 350 if the content is not a match.

An embodiment may also utilize information relating to previous or current electronic communications with an individual e.g., the content of an ongoing email chain with a group of people, a continuous IM message, or any electronic communication to detect language content at 320. Additionally, an embodiment may utilize a contact stored in the electronic device, e.g., to which a message being typed is directed, which may include a user history containing previously entered or received content associated with the contact, and/or application data, e.g., a stored language content associated with a particular application or specified by a particular application to determine the language type. It should be noted, that these are non-limiting examples, and that an embodiment may analyze any content data that is displayed on a display device, or stored within an application e.g., metadata about a previously edited version of a document.

The content language may also be detected after a user input is received at the input component. For example, an embodiment may receive a user input prior to gaining access to stored content data, e.g., the first page of a form containing input fields may contain no existing text. Once content data becomes available, e.g., the user advances to additional pages containing existing text from which to gather content, the language type is updated to match the existing content, e.g., 340 if the content is a match and 350 if the content is not a match. In addition, an embodiment may convert any previous user input provided (currently or historically) to the new language after the automatic switching of the language type at 350.

As another example, an embodiment may automatically switch an English language setting to a German language setting at 350 responsive to detecting at 320 that content indicates the user is employing a language learning tool for German language input. Likewise, an embodiment may automatically switch an English language setting to a French language setting at 350 responsive to detecting at 320 that the user has typed the beginning of a word using English letters that matches or maps to a French language word. As described herein, an embodiment may convert previous user input provided to the input component to a new language after the automatic switching has occurred. The changed language setting may persist until another mismatch is detected at 330.

Additionally, an embodiment may solicit user feedback or confirmation prior to or after the automatic switching, e.g., to improve performance. For example, an embodiment may provide a notification to a user of the automatic switching, e.g., visual notification of a suggested switch, which may include the input converted to the new language as a preview. An embodiment may wait, e.g., a predetermined time, to receive a user input in response to the notification, for example prior to implementing the automatic switching (or not implementing the automatic switching). An embodiment may also adjust the automatic switching according to the user input, e.g., inputting only a single converted word or phrase, implementing a global language setting change, and/or reversing an automatic switching that took place prior to user confirmation or feedback.

The various embodiments described herein thus represent a technical improvement to facilitating convenient switching between language settings (back and forth in real time) given the language content detected. The language content may be detected in a variety of ways, as described herein, and these methods of detecting language content may be combined. Once a mismatch has been determined, an embodiment may provide the user with a notification thereof, such that the user remains in control of the automatic switching. Learning over time may be implemented, e.g., storage and processing of prior language switching, such that an embodiment implements and/or suggests language switches that more closely match the user's desires.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
implementing, using a processor, a current language setting for an input component of an electronic device;
detecting, using a processor, a language type based on content data;
determining, based on the content data, if the language type is mismatched with the current language setting; and
responsive to the determining, automatically switching, using a processor, the current language setting to a language setting matching the language type.

2. The method of claim 1, wherein the content data used to detect the language type comprises user input to the input component.

3. The method of claim 1, wherein the input component comprises an on screen keyboard.

4. The method of claim 1, wherein the content data used to detect the language type comprises text displayed on a display device.

5. The method of claim 4, wherein the analyzing text displayed on a display device comprises analyzing the text displayed in an active application.

6. The method of claim 4, wherein the analyzing text displayed on a display device comprises analyzing the text displayed in a received electronic communication.

7. The method of claim 6, wherein the received electronic communication is at least one of: a messaging application, an electronic mail, and audio data.

8. The method of claim 1, wherein the automatic switching occurs after user input is received at the input component; and
wherein previous user input provided to the input component is converted to a new language after the automatic switching.

9. The method of claim 1, further comprising providing a notification to a user of the automatic switching.

10. The method of claim 9, further comprising:
receiving a user input in response to the notification; and
adjusting the automatic switching according to the user input.

11. An information handling device, comprising:
a processor;
an input component;
a memory device that stores instructions executable by the processor to:
implement a current language setting for the input component of the information handling device;
detect a language type based on content data;
determine, based on the content data, if the language type is mismatched with the current language setting; and
responsive to the determining, automatically switch the current language setting to a language setting matching the language type.

12. The information handling device of claim 11, wherein the content data used to detect the language type comprises user input to the input component.

13. The information handling device of claim 11, wherein the input component comprises an on screen keyboard.

14. The information handling device of claim 11, wherein the content data used to detect the language type comprises text displayed on a display device.

15. The information handling device of claim 14, wherein the analyzing text displayed on a display device comprises analyzing the text displayed in an active application.

16. The information handling device of claim 14, wherein the analyzing text displayed on a display device comprises analyzing the text displayed in a received electronic communication.

17. The information handling device of claim 16, wherein the received electronic communication is at least one of: a messaging application, an electronic mail, and audio data.

18. The information handling device of claim 11, wherein the automatic switching occurs after user input is received at the input component; and
wherein previous user input provided to the input component is converted to a new language after the automatic switching.

19. The information handling device of claim 11, wherein the instructions are further executable by the processor to:
provide a notification to a user of the automatic switching;
receive a user input in response to the notification; and
adjust the automatic switching according to the user input.

20. A product, comprising:
a storage device having code stored therewith, the code being executable by a processor and comprising:
code that implements a current language setting for an input component of an electronic device;
code that detects a language type based on content data;
code that determines, based on the content data, if the language type is mismatched with the current language setting; and
code that responsive to the determining, automatically switches the current language setting to a language setting matching the language type.
